(19) United States
(12) Patent Application Publication
(10) Pub. No.: US 2013/0279037 A1
(43) Pub. Date: Oct. 24, 2013

(54) Multi-Purpose Heat-Insulated Apparatus

(71) Applicant: HOI LEE ENTERPRISE (CHINA) LIMITED, New Territories (HK)

(72) Inventor: Chi Keung Wong, New Territories (HK)

(73) Assignee: HOI LEE ENTERPRISE (CHINA) LIMITED, New Territories (HK)

(21) Appl. No.: 13/745,853

(22) Filed: Jan. 20, 2013

(30) Foreign Application Priority Data
Apr. 18, 2012 (HK) 12103857.2

(51) Int. Cl. G02B 7/182

(52) U.S. Cl. CPC G02B 7/182
USPC 359/871

(57) ABSTRACT

A multi-purpose heat-insulated apparatus that includes an insulating layer, a reflective layer on top of the insulating layer and a connecting element on the surface of the multi-purpose heat-insulated apparatus. The insulating layer includes a base section, four wall sections connected to the base section, and the connecting sections at the corners of the insulating layer. The connecting element includes a first detachable link element at the connecting sections and a second detachable link element at the edge of the wall sections and corresponding connecting sections of the base section and wall sections that is linkable to the first detachable link element.

### TECHNICAL FIELD

This invention pertains to an accessory for the car, specifically, pertains to a multi-purpose sun protection mat.

### BACKGROUND

In the summer, after parking the car at an outdoor lot, the sunlight comes through the surrounding glass directly into the car's interior, causing the internal temperature of the car to rise rapidly. To prevent the interior temperature from getting too hot when the driver restarts the car, a sun protection mat can be placed in the car frame, to reduce the heat from the blazing sun. Sun protection mats usually depend on the surface reflective layer to directly reflect the sun rays, preventing heat from being absorbed, achieving the goal of blocking the sun from the parked car. The existing sun protection mats usually use framework or suspension pieces to affix it to the interior of the car windshield. When it is folded, it is inconvenient and takes up a lot of room.

### SUMMARY OF THE INVENTION

This invention must resolve the technical challenge, targets the current issue of sun protection mats taking up too much space, and provides a foldable multi-purpose heat-insulated apparatus that can also formed into a cooler bag, thermal insulating box or storage box, achieving the multi-purpose nature of the apparatus.

This invention must resolve the technical challenge with this technical approach: to construct a multi-purpose heat-insulated apparatus, it includes an insulating layer, a top reflective layer on the insulating layer and a connecting element on the surface of the multi-purpose heat-insulated apparatus. The insulating layer also includes a base section, four wall sections, a connecting section at each corner of the insulating layer. The connecting element includes a first detachable link element on the connecting section and a second detachable link element at the edge of the wall sections and corresponding connecting sections of the base and wall sections that is linkable to the first detachable link element.

In the multi-purpose heat-insulated apparatus of this invention, the connecting element may be Velcro® tape.

In the multi-purpose heat-insulated apparatus of this invention, the connecting element may be permanent magnets.

In the multi-purpose heat-insulated apparatus of this invention, there are diagonal creases within the connecting sections, and there are connection creases where the connecting section and wall section connect.

In the multi-purpose heat-insulated apparatus of this invention, there are connection creases where the base section and the wall section connect.

In the multi-purpose heat-insulated apparatus of this invention, there are internal dividing creases in the corresponding positions within the base section and the wall section.

In the multi-purpose heat-insulated apparatus of this invention, the insulating layer at the base section and the wall section includes a thermal insulating layer.

In the multi-purpose heat-insulated apparatus of this invention, the reflective layer has suction cup grommets so that the sun protection mat can be suspended by corresponding suction cups on the car windshield.

In the multi-purpose heat-insulated apparatus of this invention, there is at least one set of strap apertures where the reflection layer and the corresponding wall sections connect, and there are holding straps that span across the base section from each set of strap apertures.

In the multi-purpose heat-insulated apparatus of this invention, the second detachable link element is located on the reflective layer, the second detachable link element spans across many layers of the wall section when the sun protection mat is folded up.

The multi-purpose heat-insulated apparatus of this invention also includes a box cover, and a third detachable link element on the reflective layer that corresponds to the wall section of the insulating layer.

In this embodiment, the advantages are below: by installing the multi-purpose heat-insulated apparatus including the insulating layer and the reflective layer; the insulating layer is comprised of base section, wall sections, and connecting sections. Also, there is the first detachable link element 22 at the corresponding connecting sections between the surface of the reflective layer and the insulating layer. When the sun protection mat folds together according to the sections, it collapses into a small package, making it easy for storing; when the sun protection mat follows the preset section to link together via the first detachable link element into a box shape or a bag shape structure, it becomes a storage box, insulation box or cooler bag, achieving the multi-purpose nature of the heat-insulated apparatus.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1a shows the plan view of the multi-purpose heat-insulated apparatus of the first embodiment of this invention.

FIG. 1b shows the rear view of FIG. 1a.

FIG. 1c shows the distribution of the insulation layer of the multi-purpose heat-insulated apparatus of the first embodiment of this invention.

FIG. 2 shows the multi-purpose heat-insulated apparatus of the first embodiment of this invention in a folded state.

FIG. 2a shows a three-dimensional rear view of FIG. 2.

FIG. 2b shows FIG. 2a in a partially expanded state.

FIG. 2c shows FIG. 2a in a totally expanded state.

FIG. 3a shows the multi-purpose heat-insulated apparatus of the first embodiment of this invention partially folded to form a storage box.

FIG. 3b shows FIG. 3a in another partially folded state.

FIG. 3c shows a three-dimensional view of the multi-purpose heat-insulated apparatus of this invention folded to form a box.

FIG. 4a shows the multi-purpose heat-insulated apparatus of the second embodiment of this invention in a totally expanded state.

FIG. 4b shows a rear view of FIG. 4a.

FIG. 4c shows the distribution of the insulating layer in the multi-purpose heat-insulated apparatus of the second embodiment of this.

FIG. 5a shows the three-dimensional view of the multi-purpose heat-insulated apparatus of the second embodiment of this invention in a foldup state.

FIG. 5b shows another three-dimensional view of the multi-purpose heat-insulated apparatus of the second embodiment of this invention in a foldup state.

FIG. 5c shows the multi-purpose heat-insulated apparatus of the second embodiment of this invention as a sun protection mat.

FIG. 5d shows the three-dimensional rear view of FIG. 5c.

FIG. 5e shows the multi-purpose heat-insulated apparatus of this invention partially folded to form a cooler bag.

FIG. 5f shows another view of the multi-purpose heat-insulated apparatus of this invention partially folded to form the cooler bag.

FIG. 5g shows the three-dimensional view of the multi-purpose heat-insulated apparatus of this invention folded to form the cooler bag.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

In this invention of a multi-purpose heat-insulated apparatus, it includes the insulating layer and the reflective layer 10 that binds to the surface of the insulating layer. In that, the insulating layer is comprised of base section 5, wall sections 7 around the base section 5, connecting sections 8 between the two wall sections 7; the first detachable link element 22 is at the corresponding connecting section between the surface of the reflective layer and the insulating layer. When all the sections are folded, so that base section 5 and the wall sections 7 form a box shape with five sides, the connecting sections 8 lie folded up to where the wall sections 7 meet, using the first detachable link element 22 to attach all the sections together, making the whole insulating apparatus into a box shape, as a storage box for storing things.

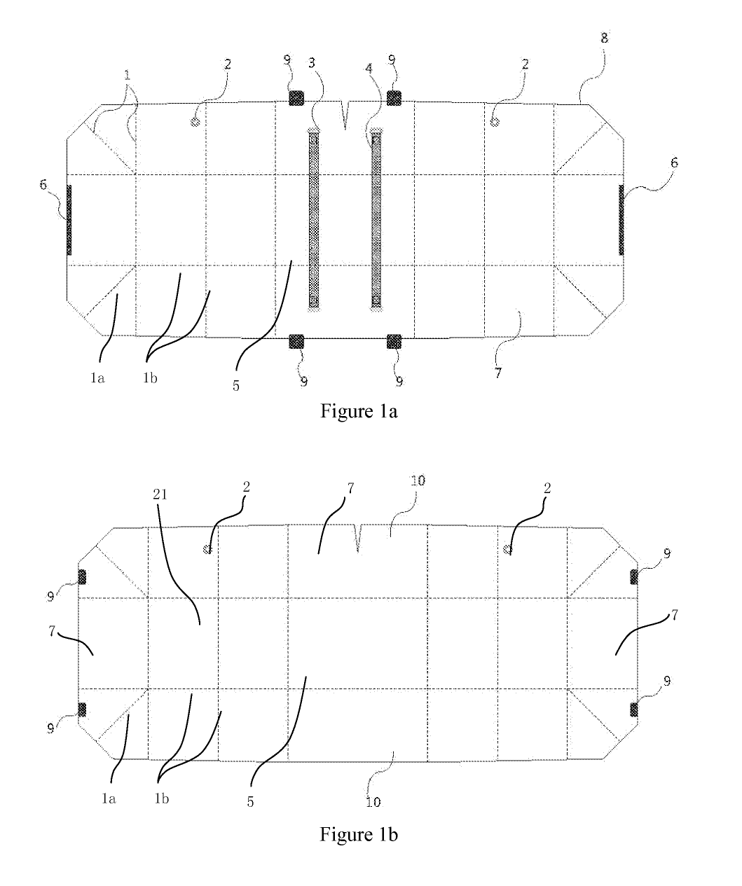

As shown in FIGS. 1a, 1b, 2, 2a, 2b, 2c, 3a, 3b, and 3c, in the first embodiment of the multi-purpose heat-insulated apparatus, it includes the insulating layer and the reflective layer, in that the reflective layer binds to the surface of the insulating layer. The insulating layer is comprised of the base section 5, the wall sections 7, and the connecting sections 8. As FIGS. 1a and 1b show, insulating layer includes a rectangular base section 5, wall sections 7 that are connected to the four edges of the base section 5, and the four connecting sections 8 that are connected to the two neighboring wall sections 7. At the corresponding position where the top of reflective layer 10 connects to the insulating layer there is a connecting element which includes the first detachable link element 22 from the connecting sections 8 and the second detachable link element 9 from corresponding position of the edge section of the wall sections 7 and the connecting sections 8 where the base section 5 and the wall sections 7 meet, the connecting element can be Velcro® (registered trademark of Velcro Industries of Netherlands), permanent magnets, or similar attachment or fastener known to one skilled in the art.

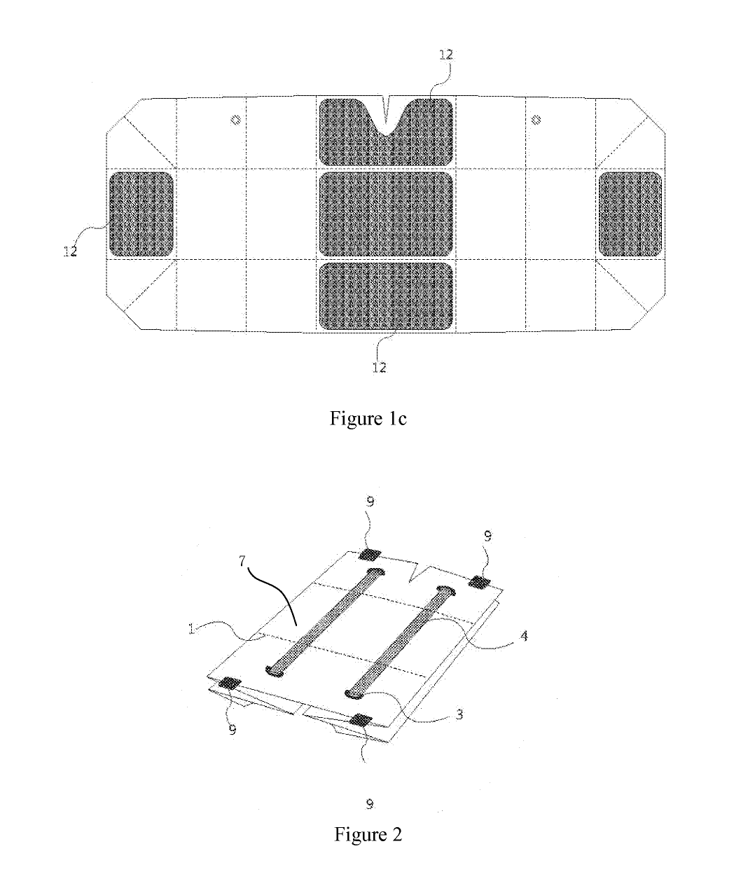

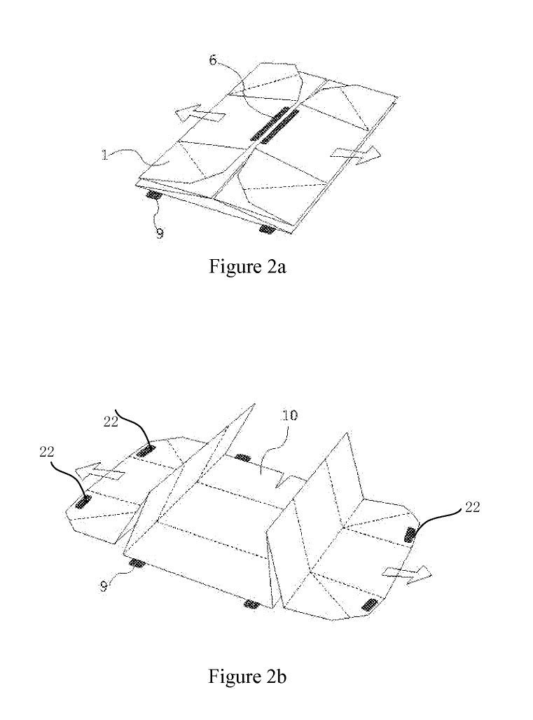

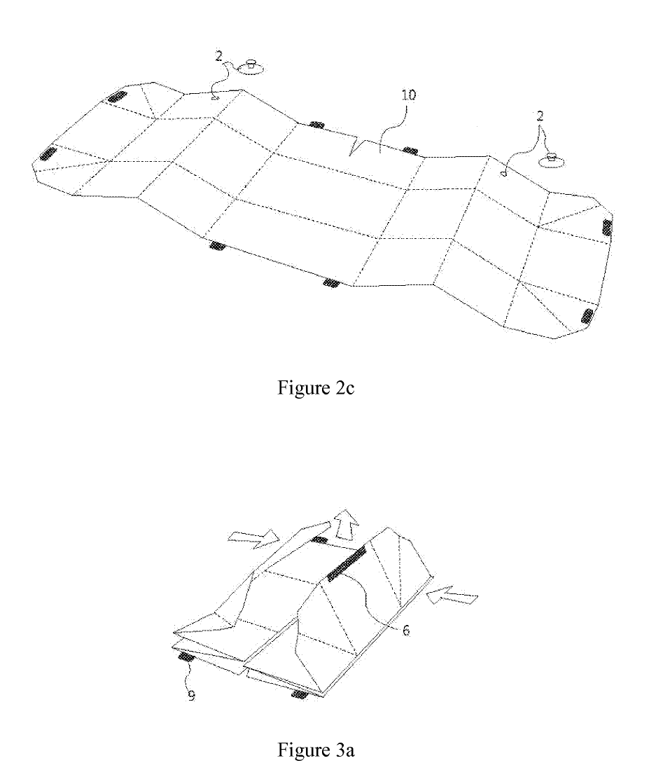

In this embodiment, preferably there are connection creases 1 where wall sections 7 and the base section 5 meet and where connecting sections 8 and the wall sections 7 meet; and a diagonal crease 1a inside the connecting sections 8. To minimize the size of the sun protection mat after it is folded up, preferably there is a separate folding section 21 in between the base section 5 and the wall sections 7, there are internal division creases 1b between the folding section 21 and base section 5 or between the wall sections 7, there may be extra internal division creases 1b within the folding section 21. As FIG. 2 shows, when folding up the entire sun protection mat, by following the connection creases 1 and the internal division creases 1b when folding, resulting in a fairly small package, making it easy for storage.

As shown in FIGS. 2a, 2b, and 2c, when it is necessary to spread out the packed sun protection mat to shield the sun, first spread out according to the connection creases 1 or internal division creases 1b of each section, then push the suction cup through the suction cup grommets 2 on the mat to attach to the windshield

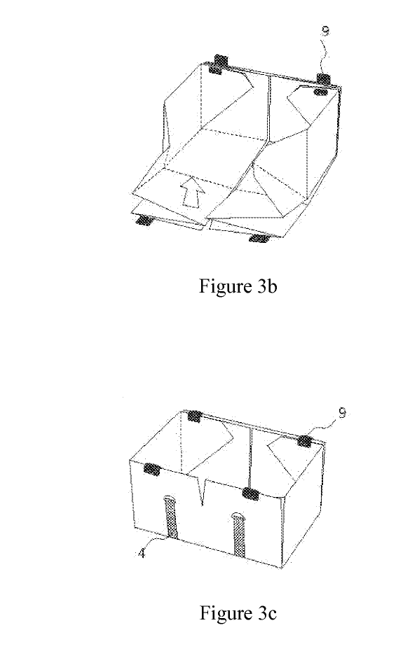

As shown in FIGS. 3a, 3b, and 3c, when it is necessary to turn the folded up sun protection mat into a storage box, first stand the four wall sections 7 up along the connection creases 1, fold the connecting sections 8 along the diagonal creases 1a through the first detachable link element 22 to attach to the wall sections 7, this creates a box shape out of the four standup wall sections 7 and the base section 5, becoming a storage box. In that, folding sections 21 does not need to spread out and can stay folded up in the base section 5 or wall sections 7.

In the embodiment as shown in FIG. 1c, it is possible to add a thermal insulating layer to the insulating layer in the base section 5 and the wall sections 7, the thermal insulating layer is filled with thermal material. This way, when the entire sun protection mat is formed into a storage box, all the walls have thermal and insulation layer, so that the storage box has thermal functionality. Specifically, sections that correspond to the folding sections 21 do not have thermal insulating layer, so that only the wall section 7 and the base section 5 have one piece of thermal insulating layer, this is to prevent doubling up of thermal insulating layers when the folding sections 21 are folded up, this is wasteful and also makes it hard to fold. The thermal layer should use the connection creases 1 and the internal division creases 1b as a guide to determine which of the corresponding sections are, this will make it easier to fold up.

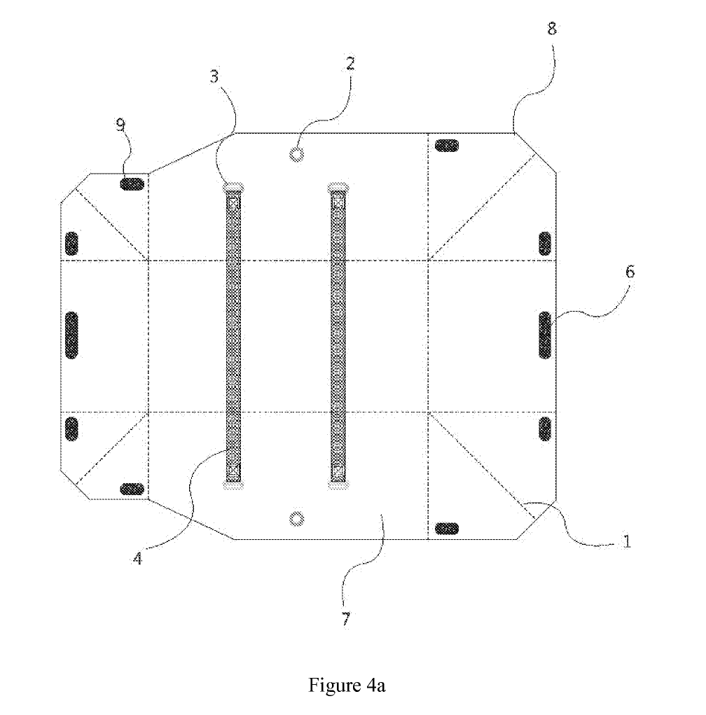

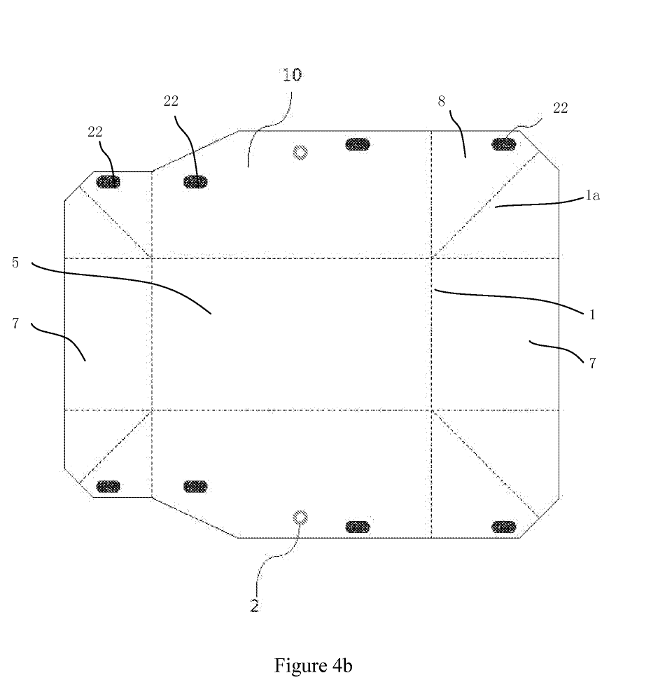

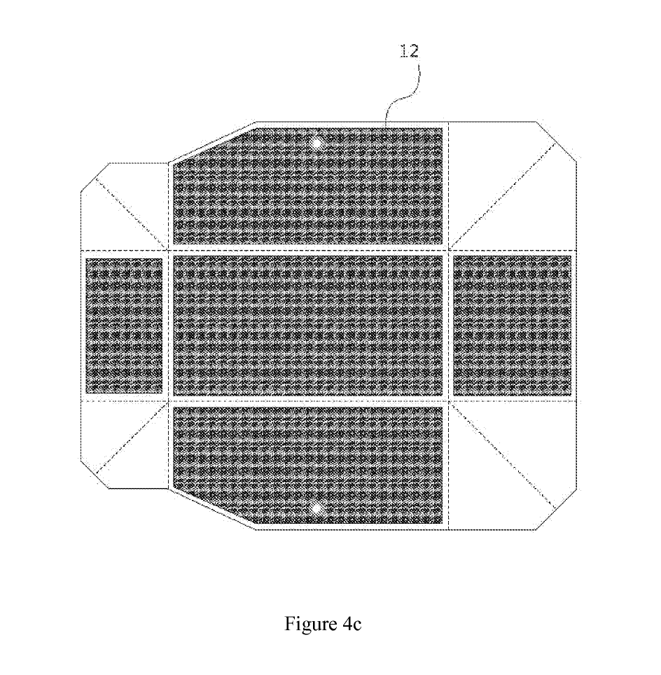

As shown in FIGS. 4a and 4b, in the second embodiment of the multi-purpose heat-insulated apparatus, the sun protection mat can form into a cooler bag, to have thermal functionality. Similarly the multi-purpose heat-insulated apparatus includes an insulating layer and a reflective layer 10, the insulating layer is comprised of a base section 5, wall sections 7, and connecting sections 8. As FIGS. 4a and 4b show, insulating layer includes a rectangular base section 5, the four wall sections 7 that are connected to the four edges of the base section 5, and four connecting sections 8 that are connected between the two neighboring sides of the two wall sections 7. The first detachable link element 22 is at the corresponding position in the folding section 21 where the reflective layer 10 and insulating layer meet, the first detachable link element 22 can be Velcro®, permanent magnets or other attachments or fasteners known to one skilled in the art.

As FIG. 4c shows, in the embodiment, it is possible to include a thermal layer to the insulating part of the base section 5 and the wall sections 7, which will add thermal functionality to the cooler bag.

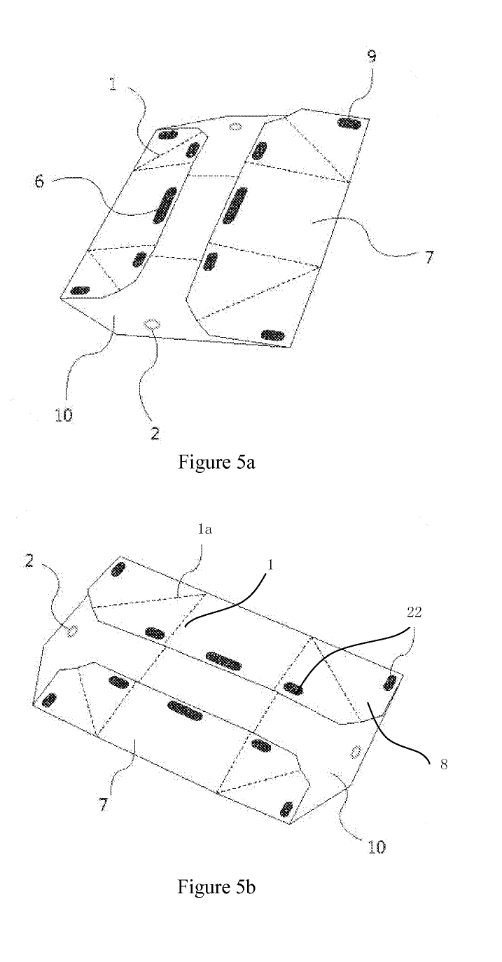

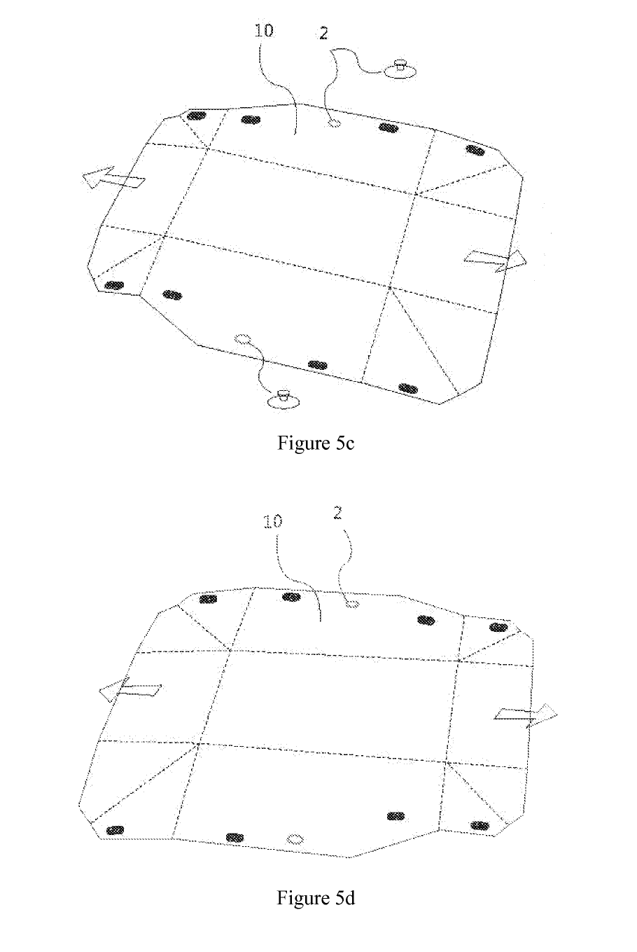

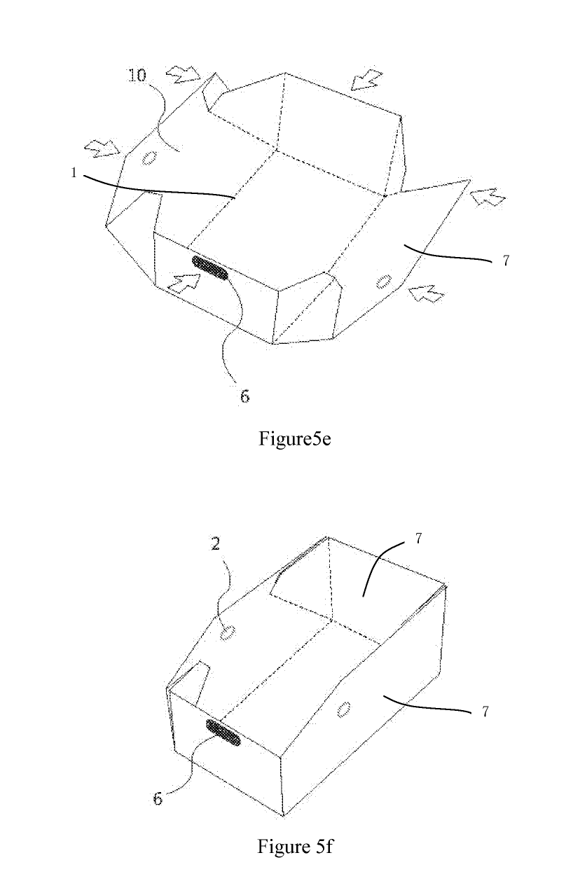

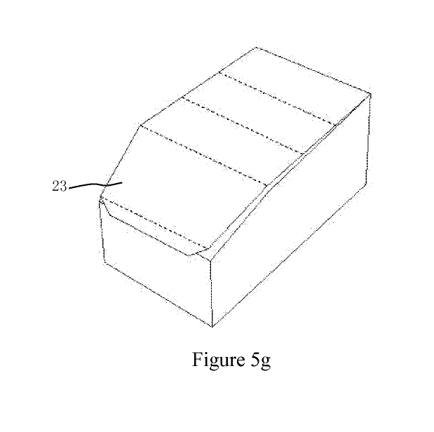

As shown in FIGS. 5a, 5b, 5c, and 5d, when it is necessary to spread out the packed sun protection mat to shield the sun, follow the connection creases 1 or internal division creases 1b of each section to spread out, push the suction cup through the suction cup grommets 2 on the mat to attach to the windshield.

As shown in FIGS. 5e and 5f, when it is necessary to turn the folded up sun protection mat into a cooler bag or thermal box, first stands the four wall sections 7 up along the connection creases 1, folds the connecting sections 8 along the diagonal creases 1a through the first detachable link element 22 to attach to the wall sections 7, this creates a box shape from the four standup wall sections 7 and the base section 5, thus the reflective layer 10 becomes the interior surface of the box, maintaining the temperature of the box contents. Additional thermal function from the thermal insulating layer increases the thermal functionality, allowing this apparatus to be a cooler bag or thermal box

As shown in FIGS. 5f and 5g, this embodiment also includes box top 23, and there is the third detachable link element 6 on the reflective layer 10, specifically, the third detachable link element 6 is at the corresponding position to the wall sections 7 of the insulating layer, this way the box top 23 is fixed in position by that third detachable link element 6 onto the wall sections 7, when it is formed into the cooler bag, the box top 23 can close over the four walls, turning the cooler bag into sealed space, which will add thermal functionality.

In the embodiments above, preferably there is suction cup grommets 2 on the reflective layer 10, the sun protection mat can be suspended on the windshield by suction cups, the suction cups pass through the suction cup grommets 2 to secure the sun protection mat.

In the embodiments above, preferably there are two sets of strap apertures 3 and two holding straps 4 on the reflective layer 10, each set of strap apertures 3 includes two strap apertures, and the two ends of each holding strap 4 are secured to the two strap apertures 3 of the same set. Specifically, the two strap apertures 3 of each of the set are installed on corresponding wall sections 7, so that the holding straps 4 straddle the base section 5. This way, when the sun protection mat is folded to form a storage box, the holding straps 4 are on the bottom of the base section 5, transferring part of the weight bearing function to the wall sections 7, so that the storage box functions well.

In the embodiments, preferably there is the second detachable link element 9 on the reflective layer 10, specifically the second detachable link element 9 is installed on the edge of the wall sections 7, and the second detachable link element 9 can be Velcro® or other attachments or fasteners known to one skilled in the art. When the sun protection mat is packed up, the second detachable link element 9 can span across several wall sections 7, connecting up both the inner and the outer layers of wall sections 7, resulting in a fairly small package, making it easy for storage.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A multi-purpose heat-insulated apparatus having a surface comprising:
an insulating layer having corners comprises a base section, four wall sections extending from said base section, and a connecting section at each corner of said insulating layer;
a reflective layer on top of said insulating layer; and
a connecting element on the surface of the multi-purpose heat-insulated apparatus, comprises a first detachable link element and a second detachable link element at the edge of at least one of said wall section and at least one of said connecting section that is linkable to said first detachable link element.

2. The multi-purpose heat-insulated apparatus of claim 1 wherein said connecting element is a Velcro® tape.

3. The multi-purpose heat-insulated apparatus of claim 1 wherein said connecting element is a set of permanent magnets.

4. The multi-purpose heat-insulated apparatus of claim 1 further comprising at least one diagonal crease within said connecting section and at least one connection crease where said connecting section and said wall section connect.

5. The multi-purpose heat-insulated apparatus of claim 1 further comprising at least one connection crease where said base section and said wall section connect.

6. The multi-purpose heat-insulated apparatus of claim 4 further comprising at least one internal dividing crease in the corresponding positions within said base section and said wall sections.

7. The multi-purpose heat-insulated apparatus of claim 1 wherein said base section and said wall section of said insulating layer having a thermal insulating layer.

8. The multi-purpose heat-insulated apparatus of claim 1 further comprising at least one suction cup and wherein said reflective layer having at least one suction cup grommet so that the apparatus can be adapted to be suspended by said corresponding suction cups on a car's windshield to serve as a sun protection mat.

9. The multi-purpose heat-insulated apparatus from of claim 1 further comprising at least one set of strap apertures where said reflection layer and said corresponding wall sections connect, and at least one holding strap that span across said base section from each set of strap apertures.

10. The multi-purpose heat-insulated apparatus of claim 1 wherein said second detachable link element is located on said reflective layer, said second detachable link element spans across a plurality of said wall sections when the apparatus is folded up.

11. The multi-purpose heat-insulated apparatus of claim 1 further comprising a box cover and a third detachable link element on said reflective layer that corresponds to said wall sections of said insulating layer.
